(19) United States
(12) Patent Application Publication
(10) Pub. No.: US 2021/0167955 A1
(43) Pub. Date: Jun. 3, 2021

(54) DATA TRANSMISSION

(71) Applicant: Bitcache Limited, Auckland (NZ)

(72) Inventors: Mamdhooh RAMEEZ, Fuveau (FR); Emmanuel Jacques GADAIX, Bangkok (TH)

(21) Appl. No.: 16/772,102

(22) PCT Filed: Oct. 23, 2018
(86) PCT No.: PCT/NZ2018/050149

§ 371 Date: Jun. 11, 2020

(30) Foreign Application Priority Data
Oct. 24, 2017 (NZ) 736669

(51) Int. Cl. H04L 9/08; H04L 9/14

(52) U.S. Cl. CPC H04L 9/0861; H04L 9/14; H04L 9/0891; H04L 9/0822

(57) ABSTRACT

A method comprising the steps of: receiving first encrypted data from a first party, the first encrypted data encrypted using a first encryption key; generating a second encryption key; encrypting the first encrypted data using the second encryption key to generate dual encrypted data, having a second encryption layer; receiving a request for data corresponding to the first encrypted data; generating third encryption and decryption keys based on the second encryption key; and re-encrypting the second encryption layer of the dual encrypted data with the third encryption key to create re-encrypted dual encrypted data, the second encryption layer being decryptable with the third decryption key.

### FIELD

This invention relates to an approach to data transmission.

### BACKGROUND

A data owner may wish to transmit data to one or more users. Data created by a content creator may be stored at a separate data store. Other parties may be allowed to access that data. This allows data sharing via an intermediary.

However, such approaches may require the data store to maintain control of the data. If the data store has insufficient security or is compromised, the original data may become public. In addition, the data is accessible to the data store itself, which may be undesirable in some cases.

While the data may be encrypted by the content creator before storage, this requires the content creator to selectively provide the key to authorized users. Thus, authorization must be administered by the content creator, which may also be undesirable in some cases. For example, it may be undesirable for the content creator and the user to be directly in contact.

It is an object of the invention to provide an approach to data transmission or to at least provide the public or industry with a useful choice.

### SUMMARY

According to an example embodiment there is provided a method comprising the steps of: receiving first encrypted data from a first party, the first encrypted data encrypted using a first encryption key; generating a second encryption key; encrypting the first encrypted data using the second encryption key to generate dual encrypted data, having a second encryption layer; receiving a request for data corresponding to the first encrypted data; generating third encryption and decryption keys based on the second encryption key; and in response to the request, re-encrypting the second encryption layer of the dual encrypted data with the third encryption key to create re-encrypted dual encrypted data, the second encryption layer being decryptable with the third decryption key.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1A is a sequence diagram of a first part of an approach for data transmission from an owner.

FIG. 1B is a sequence diagram of a second part of an approach for data transmission from an owner.

FIG. 1C is a sequence diagram of a third part of an approach for data transmission from an owner.

FIG. 2A is a sequence diagram of a first part of a user obtaining data.

FIG. 2B is a sequence diagram of a second part of a user obtaining data.

FIG. 3 is a block diagram of an example system.

### DETAILED DESCRIPTION

In some embodiments, a method for sharing data between a first party (such as an owner of the data) and a second party (such as a user of the data) is provided using an intermediary. The data may be encrypted by the first party using a first key and decrypted by the second party using the first key. The first key may not be provided to the intermediary, and so the intermediary is not able to obtain the original data from the encrypted data. In addition, the intermediary may encrypt the data at storage using a second key and re-encrypts it with a user-specific key when the user is authorized. Thus, even if the data was somehow inadvertently accessed by an unauthorized user, they would not be able to decrypt the file since they do not have the second key. Thus, only an authorized user can obtain the original data.

The intermediary may be a single entity, but in many cases comprises three distinct systems: an authorization system, an encryption system, and a storage system.

### Storing the Data

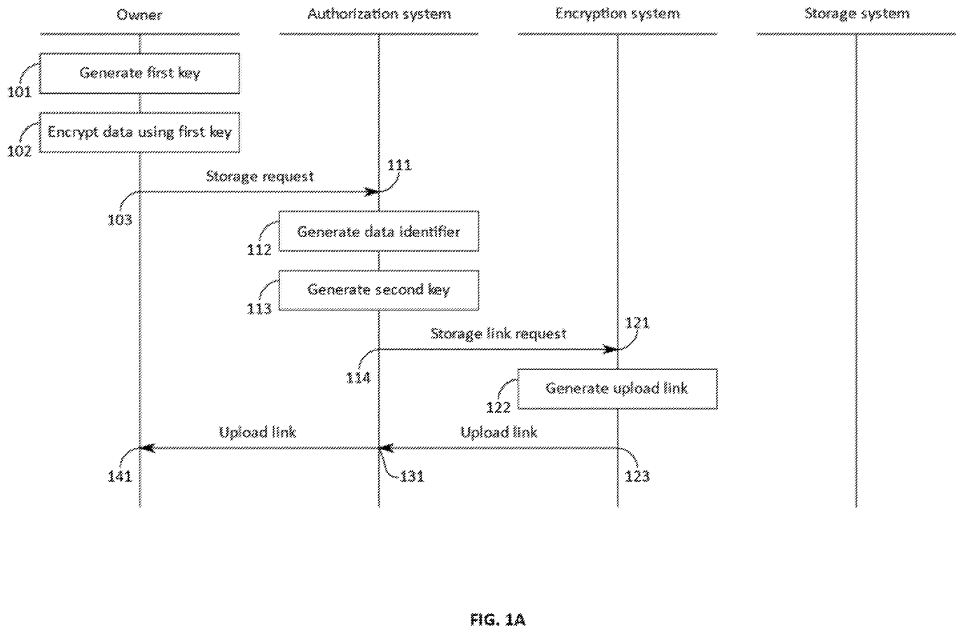

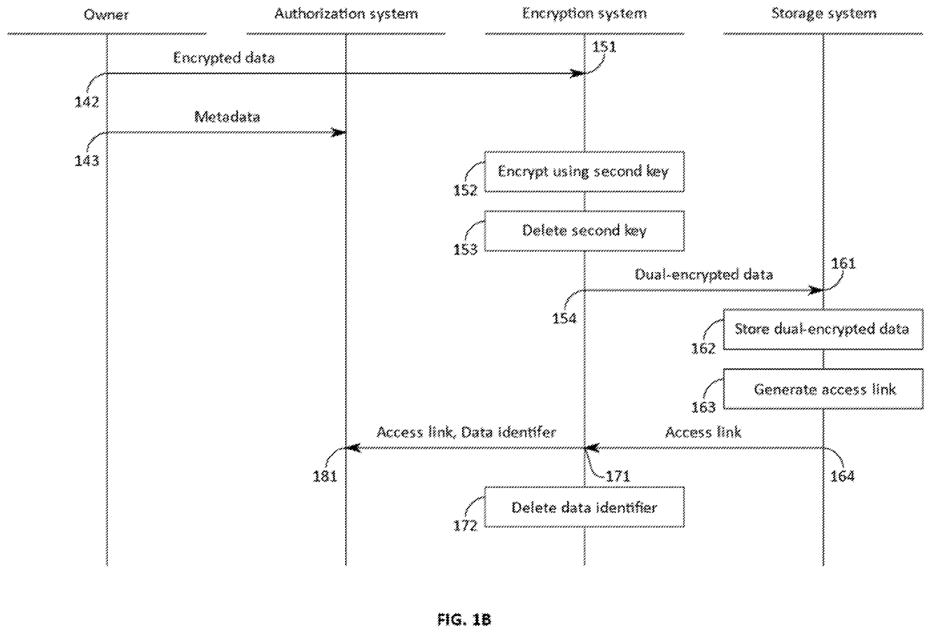

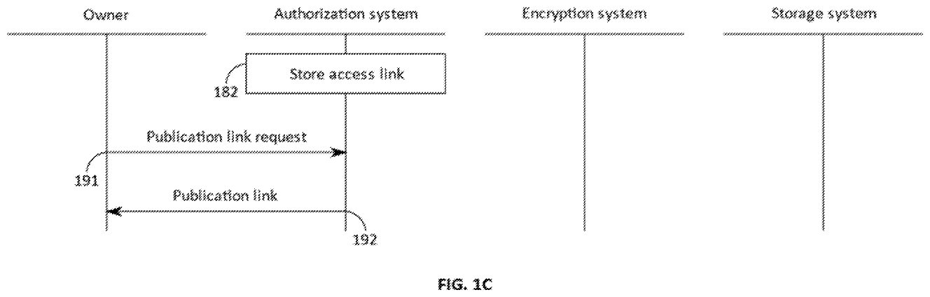

FIGS. 1A, 1B, and 1C show an overview of how data is transmitted from an owner via an intermediary. The approach begins at FIG. 1A, continues at FIG. 1B, and concludes at FIG. 1C.

A first party (the owner) has a piece of data. The owner may be any entity having some kind of data and need not necessarily own the data in any technical or legal sense. The data may be a file or any other arrangement of data.

At step 101, the owner generates a first key. In some cases, the first key is intended to be a shared secret for use in a symmetric encryption algorithm. The first key may be generated specifically for a single piece of data, though in some cases can be reused. The first key is stored by the owner such that the owner can recover the key. Storage may involve encrypting the first key.

At step 102, the owner encrypts the data using the first key. This generates encrypted data. In some cases, encryption may be symmetric encryption based on a shared secret (that is, the first key). The original data can only be recovered from the encrypted data (at least within a reasonable time frame and using reasonable resources) using the first key.

At step 103, the owner sends a storage request to an authorization system. The authorization system may be associated with an intermediary. The storage request need not comprise the encrypted data but may instead just be a request to authorize and/or set up storage. The request may comprise one or more of an identifier of the owner, authentication information of the owner, or a file size of the encrypted data. The request may be sent over a network such as the Internet and may make use of an API of the authorization system.

At step 111, the authorization system receives the storage request, and may verify one or more details of the storage request. For example, the authorization system may verify that the owner can store data by verifying that authentication information of the owner in the storage request is valid and verifying that there is sufficient storage space for the specified file size.

At step 112, the authorization system generates a data identifier. For example, the data identifier may be a randomly-generated GUID (globally unique identifier). This may be based on the owner's identifier or may be provided by the owner. The data identifier is then stored by the authorization system.

At step 113, the authorization system generates a second key. The second key is intended to encrypt data received in association with the request. In some cases, the second key is intended to be a shared secret for use in a symmetric encryption algorithm. The second key may be generated specifically for a request and/or an owner, though in some cases may be common to multiple requests and/or owners at the authorization system. The authorization system stores the second key.

At step 114, the authorization system sends a storage link request to an encryption system. The storage link request may comprise one or more of the data identifier and the second key. The storage link request may further comprise one or more of the details included in the storage request received at step 111.

The encryption system may be associated with the intermediary but may be separate from the authorization system. Alternatively, the encryption system is integrated with the authorization system. In such a case, “sending” may mean calling via an interface.

At step 121, the encryption system receives the storage link request, and may verify one or more details of the storage link request. For example, the encryption system may verify that the authorization system is authorized to send storage link requests.

At step 122, the encryption system generates an upload link, which may be a URL. The upload link may be based on the data identifier. For example, the upload link may be a URL based on a predetermined domain and the data identifier. Alternatively, the upload link may be randomly generated.

The upload link corresponds to the encryption system. That is, data sent using the upload link will arrive at the encryption system.

The encryption system may store the data identifier and the second key in memory, which may be volatile or otherwise transient. As will be noted below, because the data identifier and the second key may be deleted by the encryption system, and so immutable or otherwise permanent data storage may not be desirable in some cases.

In some cases, the upload link may be a handle or some other kind of identifier. While the term “link” is used, this does not necessarily mean a hyperlink.

At step 123, the encryption system sends the upload link to the authorization system. This may be included in an acknowledgement that the storage link request has been successful.

At step 131, the authorization system receives the upload link from the encryption system and sends the upload link to the owner. Because the encryption system does not have details of the owner, the authorization system acts as a relay. The authorization system therefore need not store the upload link once it has been forwarded.

In some cases, if an address of the owner is previously provided to the encryption system (such as in the storage link request), the encryption system may be able to send the upload link directly to the owner.

At step 141, the owner receives the upload link from the authorization system.

At step 142, the owner uploads the encrypted data to the encryption system using the upload link. For example, if the upload link is a URL, the upload may occur using FTP or HTTP. In some cases, the upload link corresponds to a website. Using a form on that website, the owner may upload the encrypted data.

While the term “upload” is used, this may involve any kind of sending from the owner. In some cases, sending an email or other kind of message may constitute uploading.

At step 143, the owner sends metadata to the authorization system. The metadata is based on the original data, and may include a file name, a file size, a checksum or any other information relating to the original data or the encrypted data. The owner may receive an acknowledgement of this from the authorization system once stored.

At step 151, the encryption system receives the encrypted data uploaded at step 142. In this case, receiving may mean that the data is written to a particular location, such as a predetermined directory. The encryption system may send an acknowledgment of receipt to the owner, which may include a checksum computed from the received encrypted data.

At step 152, the encryption system encrypts the encrypted data received at step 151 using the second key received at step 121 with the storage link request. This generates dual-encrypted data. A first encryption layer is provided via the first key, and a second encryption layer is provided via the second key. Thus, both the first key and the second key are required to obtain the original data.

Since the encryption system does not have the first key, the encryption system cannot obtain the original data.

At step 153, the encryption system deletes the second key. Deleting may include writing over memory associated with the second key so that it is not accessible. In some cases, there may be provable deletion.

After step 153, the encryption system has neither the first key nor the second key, and therefore cannot overcome either encryption layer.

At step 154, the encryption system uploads the dual-encrypted data to a storage system. This may include sending the data over a network.

The storage system may be associated with the intermediary but may be separate from the encryption system. Alternatively, the storage system is integrated with the encryption system. In such a case, “sending” may mean calling via an interface.

At step 161, the storage system receives the dual-encrypted data. In this case, receiving may mean that the data is written to a particular location, such as a predetermined directory.

At step 162, the storage system stores the dual-encrypted data. For example, the dual-encrypted data may be stored using a storage device or storage array. This may be local to the storage device or may be located on remote storage across a network. Storing may involving adding parity information. However, because the storage system does not have the first key or the second key, the storage system cannot obtain the original data.

At step 163, the storage system generates an access link for use in obtaining the dual-encrypted data. The access link may be a URL or another identifier. For example, the access link may be provided to an interface, such as a website, to obtain a URL from which the dual-encrypted data can be obtained.

At step 164, the storage system sends the access link to the encryption system. This may occur with an acknowledgment of receiving the dual-encrypted file at step 161 and/or as an acknowledgement that the dual-encrypted file has been stored at step 162.

At step 171, the encryption system receives the access link from the storage system and sends the access link and the data identifier to the authorization system. Because the storage system does not have details of the authorization system, the encryption system acts as a relay. The encryption system therefore need not store the access link once it has been forwarded.

At step 172, the encryption system deletes the data identifier. Deleting may include writing over memory associated with the second key so that it is not accessible. In some cases, there may be provable deletion.

After step 172, the encryption system may have no record of the encrypted data or any information related to it.

At step 181, the authorization system receives the access link from the encryption system.

At step 182, the authorization system stores the access link received at step 181. This may be stored in association with the data identifier.

At step 191, the owner sends a publication link request to the authorization system. The publication link request requests a publication link for the dual-encrypted data. The publication link request may include a reference to the encrypted data, such as the data identifier.

At step 192, the authorization system sends a publication link to the owner. The publication link may be based on the access link but may be configured to refer to the authorization system. For example, the publication link may be a URL corresponding to the authorization system. It may be generated on receiving a request at step 191 (such that a new publication link is generated in response to each request), or a single publication link may be used in response to multiple requests.

The purpose of the publication link may be to allow another party to obtain the encrypted data. In some cases, the publication link can be made freely available so that any party can obtain the dual-encrypted data. However, because no other party necessarily has both the first key and the second key, the data itself cannot be recovered (at least within a reasonable time frame and using reasonable resources).

Thus, data can be secured by limiting access to the first key and the second key without necessarily the need to control access to the data.

### Obtaining the Data

As noted above, data may be stored by an owner for access by one or more users. The data is dual-encrypted, with a first encryption layer based on a first key and a second encryption layer based on a second key.

In use, the owner may make the publication link and the first key public. Even if this were enough to obtain the dual-encrypted data, a user would still not have access to the second key, and therefore could not remove the second encryption layer. Thus, there may be a reduced need to control the data itself.

In practice, the owner may limit the provision of one or both of the publication link and the first key to certain users. While not necessary, this can provide an additional layer of security.

Once a user has the publication link, they may attempt to obtain the data.

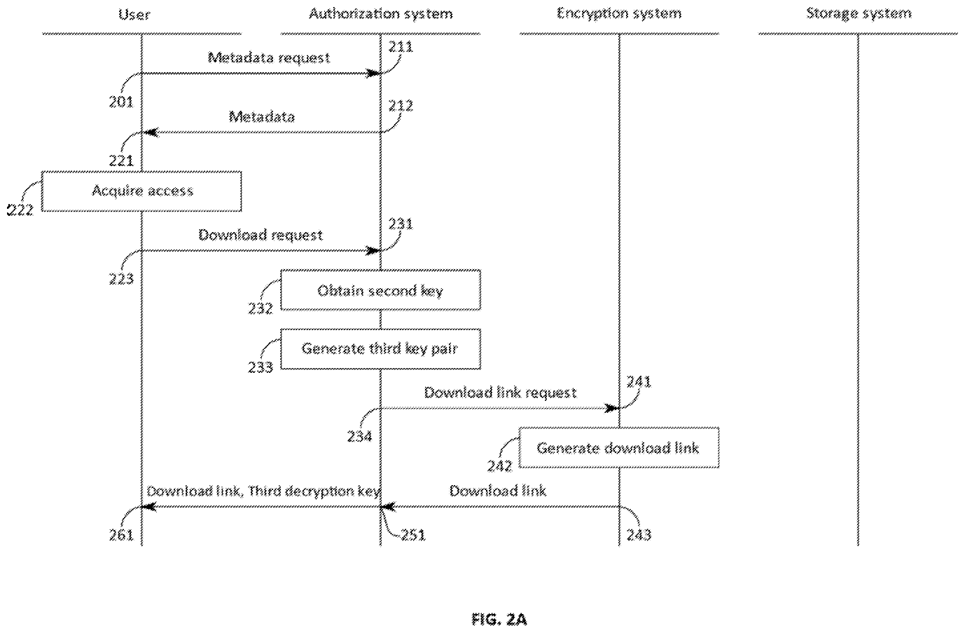

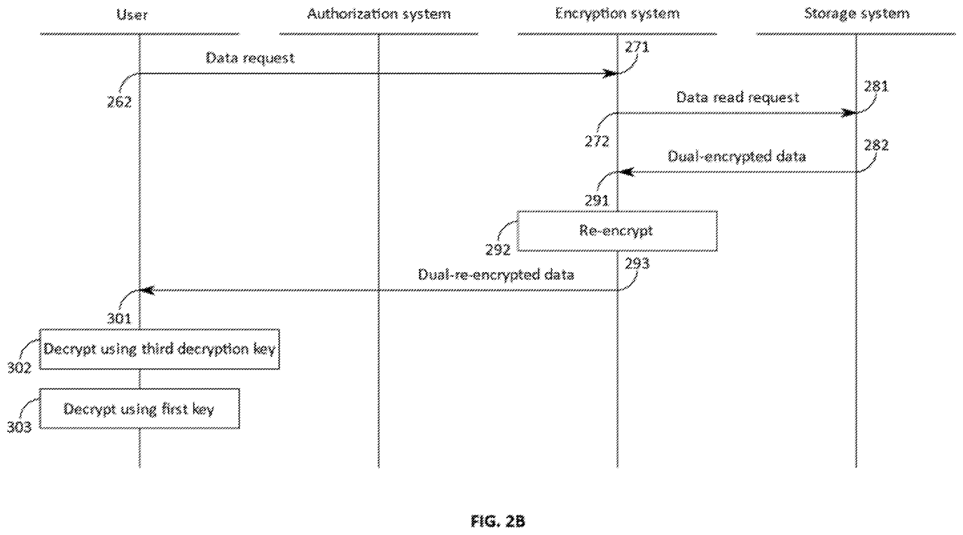

FIGS. 2A and 2B show an overview of how data is obtained by a user via an intermediary. The approach begins at FIG. 2A and concludes at FIG. 2B.

Thus, at step 201, the user sends a metadata request to the authorization system. The metadata request is a request for metadata relating to a piece of data. The metadata request may comprise an identifier of the data. For example, this may be the publication link. Alternatively, the publication link may be a URL corresponding to a website. The metadata request may involve interacting with the website.

At step 211, the authorization system receives the metadata request. The authorization system may validate the metadata request. For example, this may comprise validating that the metadata request relates to data known by the authorization system and/or that the metadata request came from a trusted source. If the metadata request is validated (or if validation is omitted), the authorization system obtains the metadata corresponding to the metadata request.

At step 212, the authorization system sends the metadata to the user.

At step 221, the user receives the metadata. In response, to the received metadata, the user may determine whether to proceed. For example, if the publication link does not relate to desired data, the user may not proceed further.

At step 222, the user acquires access to the data. This may involve authenticating the identity of the user. For example, the authentication may only allow access to users meeting certain requirements, such as belonging to a certain organisation.

Additionally or alternatively, this may involve a purchase procedure. For example, the user may purchase access to the data by paying an amount specified in the metadata. This may be processed by a merchant system, which may be associated with the authorization system. Once the purchase has been processed, this may result in an authorization code which is provided to the authorization system. When a valid authorization code is provided to the authorization system, the user may be considered to have access to the data.

Subsequently, the authorization system may cause the payment to be routed to the owner. Alternatively, this may be handled independently by the merchant system.

At step 223, the user sends a download request to the authorization system. The download request is a request to download a piece of data. The download request may comprise an identifier of the data for which a download link is requested. For example, this may be the publication link.

At step 231, the authorization system receives the download request. The authorization system may validate the download request. For example, the authorization system may validate that the download request is received from or corresponds to the user who acquired access at step 222.

At step 232, the authorization system obtains the second key corresponding to the data identified by the download request. For example, the publication link may be mapped to the second key in a data store. Alternatively, metadata associated with the data may be mapped to the second key.

At step 233, the authorization system generates a complementary third key pair, comprising a third encryption key and a third decryption key. The purpose of the key pair is for the third encryption key to encrypt the dual-encrypted data such that the third decryption key can be used to remove the second encryption layer. The third key pair may be selected for proxy re-encryption, as is described in more detail below.

Alternatively, the third key pair may be any key pair usable for asymmetric encryption. That is, the third encryption key may be a private key and the third decryption key may be a corresponding public key.

The third key pair may be user-specific and/or request-specific. That is, the third key pair may be generated based on the user who sent the download request at step 223. Thus, if the same user sends multiple download requests for the same data, this will result in the same third key pair. Alternatively, the third key pair may be generated based on the download request. Thus, if the same user sends multiple download requests for the same data, each request will be result in a new third key pair. In general, the same third key pair may not be used for different users.

At step 234, the authorization system sends a download link request to the encryption system. The download link request is a request to obtain a download link for particular data. The download link request may comprise the access link corresponding to the data (which was stored at step 182) and the third encryption key.

At step 241, the encryption system receives the download link request from the authorization system. The download link request is a request to obtain a link to data stored at the storage system. The encryption system may identify the data based on the access link. The encryption system may validate the download link request, for example by validating that the download link request relates to data stored at the storage system or that the download link request was received from a suitable authorization system.

At step 242, the encryption system generates a download link. The download link relates to the data identified by the access link. The download link may be based on the access link and may be a URL. For example, the URL may relate to a domain corresponding to the encryption system. When resolved, the URL may point to the data identified by the access link. Alternatively, the download link may be an identifier, for example, an identifier that can be provided to a website associated with the encryption system.

At step 243, the encryption system sends the download link to the authorization system.

At step 251, the authorization system receives the download link, and sends the download link and the third decryption key to the user. This may occur in an acknowledgement of or response to the download request sent at step 223. Alternatively, this may be sent separately.

After step 251, the authorization system need not retain a reference to the third decryption key, the third encryption key, or the download link. While not essential, in some cases these are deleted from the authorization system.

At step 261, the user receives the download link and the third decryption key from the authorization system. The user may store these securely.

At step 262, the user sends a data request to the encryption system. The data request is a request to obtain certain data (which may be in an encrypted form). The data request may comprise the download link. In some cases, sending a data request may comprise visiting the download link in a browser.

At step 271, the encryption system receives the data request from the user. The encryption system may validate the data request. For example, the encryption system may ensure that the data request was received from a suitable user and/or that it relates to data managed by the encryption system.

At step 272, the encryption system sends a data read request to the storage system. The data read request is a request to obtain specified data from the storage system. The data read request may comprise an identifier of the data. For example, the data read request may comprise the access link sent at step 241.

At step 281, the storage system receives the data read request from the encryption system. The storage system may validate the data read request. For example, the storage system may validate that the data read request relates to data stored by the storage system.

At step 282, the storage system sends the data to the encryption system. The data is that which was specified by the data read request. The data is dual-encrypted, in that there is a first encryption layer based on a first key and a second encryption layer based on a second key.

The dual-encrypted data may be sent over a network, such as the Internet. Alternatively, the dual-encrypted data may be written to a predetermined directly accessible to the encryption system.

At step 291, the encryption system receives the dual-encrypted data from the storage system. The encryption system may verify that the dual-encrypted data was correctly received, for example by verifying a checksum.

At step 292, the encryption system re-encrypts the dual-encrypted data using the third encryption key.

In some embodiments, this involves first decrypting the dual-encrypted data using the second key to obtain encrypted data with just the first encrypted layer.

Then the encrypted data is encrypted using the third encryption key to add a second encryption layer based on the third key pair.

Alternatively, proxy re-encryption may be used. One approach is that described in Blaze, M., Bleumer, G., and Strauss, M. 1998. Divertible protocols and atomic proxy cryptography. In Proceedings of Eurocrypt '98. Vol. 1403. 127-144, the contents of which are incorporated here by reference.

Thus, in some embodiments, the third encryption key may be configured so that, when the third encryption key is applied to the dual-encrypted data, the second encryption layer based on the second key is replaced by a second encryption layer based on the third key pair.

As a result of this, the encryption system has dual-re-encrypted data, in which a first encryption layer is based on a first key and a second encryption layer is based on a third key pair. This can be decrypted by a party having the first key and the third decryption key.

The encryption system and the storage system therefore could not obtain the original data, as it does not have either the first key or the third decryption key. The authorization system could not obtain the original data since it does not have the first key and may have deleted the third decryption key.

At step 293, the encryption system sends the dual-re-encrypted data to the user. This may occur in an acknowledgement for or a response to the data request sent at step 262. The dual re-encrypted data may be sent over a network, such as the Internet. In some cases, the network need not be a secure link since the dual-re-encrypted data could not be decrypted by an intervening party (within a reasonable time and with reasonable resources).

At step 301, the user receives the dual-re-encrypted data. The user may verify that the data was received correctly, for example by verifying a checksum.

At step 302 the user decrypts the dual-re-encrypted data using the third decryption key received at step 261. This results in encrypted data with a single encryption layer based on the first key.

At step 303, the user decrypts the encrypted data using the first key obtained directly or indirectly from the owner. This results in the original data.

In this way, access to the original data can be controlled cryptographically without the need for controlling access to the encrypted data. Because each of the entities of the intermediary does not have access to the first key, they are unable to decrypt the data. In addition, no single entity retains a key for the second encryption layer and the data itself, one entity being compromised results in a reduced risk.

Moreover, because of the use of a third encryption key pair which can be user-specific, access to the original data may be restricted to authorized users. This can be administered by the intermediary even if the intermediary does not have access to the original data.

### Encryption

Where encryption and decryption have been referred to, this may be implemented using any suitable encryption and decryption technique. For example, in the case of symmetric encryption, examples of encryption algorithms are AES and 3DES. In the case of asymmetric encryption, an example of encryption algorithms is RSA. Multiple algorithms may be chained together to form a cryptosystem. Moreover, where there is mention of a key, in some cases this includes multiple keys being used in an algorithm or cryptosystem.

While some approaches noted above have been framed in terms of symmetric encryption (using a single key), this could equally use asymmetric encryption. Similarly, where approaches have been described in terms of asymmetric encryption (using a key pair), this could equally use symmetric encryption. The choice of one or more the other may be selected accordingly to the particular implementation requirements.

### System

As noted above, there may be a number of entities involved in the described approaches.

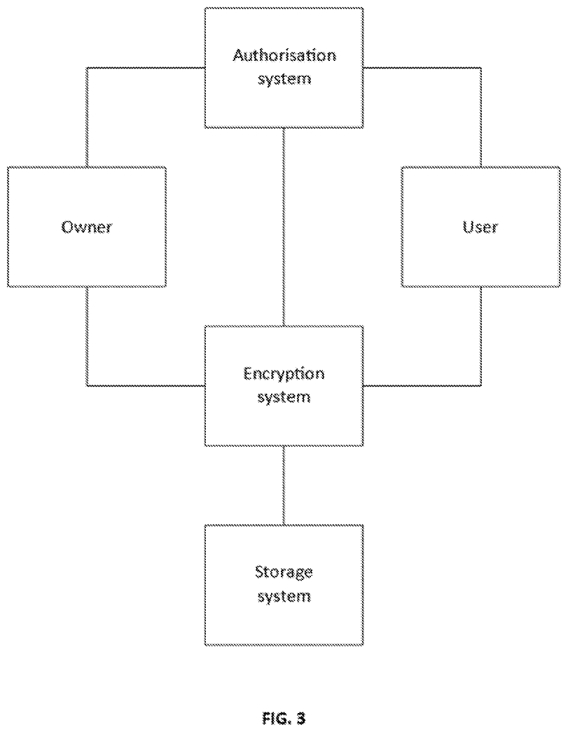

FIG. 3 shows an example of a system for performing the described embodiments.

An owner 10 is in communication with an authorization system 20 and an encryption system 30. For example, the owner 10 may set up storage with the authorization system 20 and may upload data to the encryption system 30. The owner 10 need not be in communication with the storage system 40 itself, nor with a user 50.

The owner 10 may be an individual, such as a content creator.

The authorization system 20 may provide an interface for authorizing storage and access to stored data. To this end, the authorization system 20 may be in communication with the owner 10 and the user 50. The authorization system 20 may further be in communication with the encryption system 30 for administering storage.

For example, the authorization system 20 may provide a website for a user 50 to obtain authorization for certain data, for example by making a purchase. In return, the authorization system 20 can provide one of the keys required for decrypting the dual-encrypted data.

The encryption system 30 may provide an interface for storing data and accessing stored data. To this end, the encryption system 30 is in communication with the owner 10 and the user 50, as those parties will wish to send and/or receive data. The authorization system 20 may further be in communication with the encryption system 30 for determining when storage and access are authorized and with the storage system for administering storage.

The storage system 40 provides the underlying storage of the data. The storage system 40 is in communication with the encryption system 30. Since the encryption system 30 provides an interface for storage and access, the storage system 40 need not be in communication with any other components.

The user 50 is in communication with the authorization system 20 and the encryption system 30. For example, the user 50 may obtain authorization to access data from the authorization system 20 and may obtain the data from the encryption system 30. The user 50 need not be in communication with the storage system 40 itself, nor with the owner 10.

While not shown, the first key may be transferred from the owner 10 to the user 50 directly. Alternatively, the owner 10 may make the first key public (such as on a website). Because the first key is alone not enough to access the original data, publishing the first key does not necessary leave the data unsecured.

In some embodiments, the authorization system 20, the encryption system 30, and the storage system 40 are independent. That is, each of the authorization system 20, the encryption system 30, and the storage system 40 is separate from, and does not have access to data stored at others of the authorization system 20, the encryption system 30, and the storage system 40.

One or more of the authorization system 20, the encryption system 30, and the storage system 40 may comprise one or more processors and a memory. The memory may comprise instructions which, when executed by the one or more processors, cause the one or more processors to perform one or more of the steps described above.

Additionally or alternatively, such instructions may be stored on a computer-readable medium, which may be non-transitory, and/or may form a computer program product.

Additionally or alternatively, one or more of the authorization system 20, the encryption system 30, and the storage system 40 may comprise a device having one or more modules configured to perform one or more of the steps described above.

### Interpretation

A number of methods have been described above. It will be appreciated that any of these methods may be embodied by a series of instructions, which may form a computer program. These instructions, or this computer program, may be stored on a computer readable medium, which may be non-transitory. When executed, these instructions or this program may cause a processor to perform the described methods. In some cases, there may be provided a device or system which is provided which modules, each module configured to perform one or more of the steps noted above.

While the methods noted above have been described in a particular order, this should be taken as illustrative only. That is, unless the context requires otherwise (such as a dependency), steps may be performed in any order or in parallel in different embodiments.

In addition, in some cases steps may be omitted from the overall method, unless the context requires otherwise.

The terms “comprise”, “comprises” and “comprising”, as used in this description and unless otherwise noted, are intended to have an inclusive meaning. That is, they will be taken to mean an inclusion of the listed components or elements which the use directly references, and possibly also of other non-specified components or elements.

Reference to any document in this specification does not constitute an admission that it is prior art, validly combinable with other documents or that it forms part of the common general knowledge.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept.

1. A method comprising the steps of:
receiving first encrypted data from a first party, the first encrypted data encrypted using a first encryption key;
generating a second encryption key;
encrypting the first encrypted data using the second encryption key to generate dual encrypted data, having a second encryption layer;
receiving a request for data corresponding to the first encrypted data;
generating third encryption and decryption keys based on the second encryption key; and
in response to the request, re-encrypting the second encryption layer of the dual encrypted data with the third encryption key to create re-encrypted dual encrypted data, the second encryption layer being decryptable with the third decryption key.

2. The method of claim 1 further comprising providing the re-encrypted dual encrypted data in response to the request for the requested data.

3. The method of claim 2 further comprising providing the third decryption key in response to the request for the encrypted data.

4. The method of claim 1 further comprising storing the second encryption key and/or the dual encrypted data.

5. (canceled)

6. The method of claim 1 further comprising deleting the first encrypted data after encrypting the first encrypted data using the second encryption key.

7. The method of claim 1 further comprising providing a link to the dual encrypted data to the first party.

8. (canceled)

9. The method of claim 1 wherein the request for the dual encrypted data is received from a third party.

10. The method of claim 1 further comprising sending the second encryption key and the first encrypted data to an encryption system for encryption and wherein the encryption system carries out the step of encrypting the first encrypted data using the second encryption key to generate dual encrypted data, having a second encryption layer.

11. The method of claim 10 wherein the encryption system deletes the second encryption key and the first encrypted data after encrypting the first encrypted data using the second encryption key.

12. The method of claim 10 wherein the encryption system stores the dual encrypted data.

13. The method of claim 12 wherein the encryption system stores the dual encrypted data on a separate storage system.

14. The method of claim 13 wherein the storage system is remote from the encryption system.

15. The method of claim 10 further comprising receiving a link to the dual encrypted data from the encryption system.

16. The method of claim 15 further comprising sending the third encryption key and the link to the dual encrypted data to the encryption system and wherein the encryption system re-encrypts the second encryption layer of the dual encrypted data with the third encryption key to create re-encrypted dual encrypted data, the second encryption layer being decryptable with the third decryption key, the method further comprising receiving the re-encrypted dual encrypted data from the encryption system.

17. The method of claim 10 further comprising sending an identifier related to the first encrypted data to the encryption system with the second encryption key and the first encrypted data and wherein the encryption system links the dual encrypted data with the identifier, the method further comprising sending the third encryption key and the identifier related to the dual encrypted data to the encryption system and wherein the encryption system re-encrypts the second encryption layer of the related dual encrypted data with the third encryption key to create re-encrypted dual encrypted data, the second encryption layer being decryptable with the third decryption key, the method further comprising receiving the re-encrypted dual encrypted data from the encryption system.

18. The method of claim 1 wherein the encrypted data is an encrypted file.

19. The method of claim 1 further comprising receiving authorization that the request for data corresponding to the first encrypted data is valid.

20-22. (canceled)

23. A computer-implemented method comprising:
encrypting data using a first key; and
sending the encrypted data to a system implementing the method of claim 1.

24-30. (canceled)

31. A computer-implemented method comprising:
sending a request for data to a system implementing the method of claim 1; and
receiving re-encrypted dual encrypted data from the system.

32-41. (canceled)

42. One or more non-transitory computer readable media storing computer-usable instructions that, when used by a computing device, cause the computing device to implement the method of claim 1.
